(19) United States
(12) Patent Application Publication
(10) Pub. No.: US 2009/0286526 A1
(43) Pub. Date: Nov. 19, 2009

(54) RADIO QUALITY DEGRADATION PREDICTION SYSTEM, WIRELESS TERMINAL AND MONITORING SERVER THEREFOR, RADIO QUALITY DEGRADATION PREDICTION METHOD AND PROGRAM

(75) Inventor: Yasuhiko MATSUNAGA, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Tokyo (JP)

(21) Appl. No.: 12/434,412

(22) Filed: May 1, 2009

(30) Foreign Application Priority Data
May 15, 2008 (JP) 2008-128318

(51) Int. Cl. H04M 11/00; H04L 12/26; H04W 24/00

(52) U.S. Cl. 455/421; 370/241; 455/456.1

(57) ABSTRACT

A radio quality degradation prediction system includes a wireless terminal and a monitoring server. The wireless terminal includes a positioning unit that determines a position of the wireless terminal and notifies the monitoring server of movement history of the wireless terminal via a wireless network, and a user notification unit that gives a warning to a user upon receiving a radio quality degradation alert at the wireless terminal. The monitoring server includes a future position prediction unit that predicts a future position of the wireless terminal based on the movement history of the wireless terminal, a radio propagation prediction unit that estimates radio quality in a service coverage area by using a radiowave propagation simulator, and a quality degradation prediction unit that predicts degradation of radio quality at the future position of the wireless terminal and transmits a radio quality degradation alert to the wireless terminal.

This application is based upon and claims the benefit of priority from Japanese patent application No. 2008-128318, filed on May 15, 2008, the disclosure of which is incorporated in its entirety by reference.

### TECHNICAL FIELD

Aspects of the present invention relate to management of communication quality in a wireless communication terminal, and more specifically, to a radio quality degradation prediction system, wireless terminal and monitoring server therefor, and a radio quality degradation prediction method and program that predicts degradation of quality based on radiowave propagation problems.

### DESCRIPTION OF THE RELATED ART

In wireless communication, communication quality significantly degrades in some locations (i.e., dead zones) due to blockage of radiowave by a building or terrain, influence of multi-path interference or the like. In many wireless communication systems for mobile phones or the like, some dead zones remain even after area development is completed because of the huge cost required to decrease the number of dead zones to near zero. Since the existence of such dead zones is presupposed, however, utilization of wireless communication as a reliable means of communication is hampered.

On the other hand, reliability of communication is particularly required in certain situations. For example, wireless communication used in mission-critical tasks such as rescue operations a municipality performs at the time of a disaster, communication serving as a lifeline for users who require assistance such as elderly people or children, contract requirements such as wireless communication Service-Level Agreements (SLA) implemented by a communication provider for a company, or the like.

For congestion caused by temporary traffic concentration at the time of a disaster or during an event such as a fireworks display, disaster priority connection terminals are usually prepared for preferentially connecting terminals of police, fire department or some other public organizations, with appropriate limitation on call origination applied on the network side. However, there is no effective solution for the problem of radio dead zones, and typically communication quality suddenly degrades and a call is disconnected in such a zone.

Some methods have been proposed for predicting degradation of communication quality in a wireless terminal. Japanese Patent Laid-Open No. 10-313484 (herein after “Patent Document 1”) describes a method of predicting wireless communication quality degradation, which obtains the position of a vehicle of interest from a car navigation system and information about an area in which communication seems to be unavailable from map information, such as a tunnel. And call origination is suspended when a calling operation is performed from a hands-free device immediately before entering such a communication-unavailable area.

Japanese Patent Laid-Open No. 2001-177869 (hereinafter “Patent Document 2”) describes a method for predicting wireless communication quality degradation that determines a remaining time for which a telephone call is possible from the current time, train service schedule, and map data on obstructions, such as tunnels. And, a notification is provided on a screen or with a warning tone that communication will soon become unavailable when the remaining time is short.

Japanese Patent Laid-Open No. 08-19042 (hereinafter “Patent Document 3”) discloses a method of predicting wireless communication quality degradation that continuously measures a bit error rate (BER) during communication in a wireless terminal. And, a warning tone is issued to a user and the other party to the communication when BER has dropped below a certain value.

The above described methods of predicting wireless communication quality degradation shown in Patent Documents 1 and 2 cannot predict the degradation of radiowave quality at locations other than where obstructions are present in map data due to the great complexity of radiowave propagation environments in urban areas.

Also, in recent years, countermeasures against dead zones utilizing indoor antennas or leakage coaxial cable are taken in some obstruction areas, such as tunnels. Therefore, communication is sometimes actually possible even inside an obstruction. These methods thus have a problem in accurately predicting communication quality degradation.

The above described method of predicting communication quality degradation shown in Patent Document 3 has a problem of the user being unable to respond after a warning tone is issued because degradation of radio quality occurs suddenly. This is because, in wireless communication in a non-line-of-sight environment, fluctuation in radio quality over several tens of decibels suddenly occurs due to the effect of fading associated with reflection of the radiowave or shadowing caused by a transmission path entering the shadow of a building, in general.

### SUMMARY

Embodiments of the present invention overcome the above disadvantages and also overcome other disadvantages not described above. Indeed, the present invention is not required to overcome the disadvantages described above and certain embodiments of the present invention may not overcome any of the problems described above.

An aspect of certain embodiments of the present invention is to provide a radio quality degradation prediction system that is capable of predicting future degradation of wireless communication quality in a wireless terminal sufficiently well in advance and with accuracy, and giving a warning and action assistance to a user so that the user stays within a service area.

Another aspect of certain embodiments of the present invention is to provide a radio quality degradation prediction system that is capable of predicting future degradation of radio quality in consideration of not only a terminal of interest but movement of other nearby wireless terminals in a multi-hop network in which wireless terminals relay communication.

Yet another aspect of certain embodiments of the present invention concerns a radio quality degradation prediction system including a wireless terminal and a monitoring server. The wireless terminal includes a positioning unit that determines a position of the wireless terminal and notifies the monitoring server of movement history of the wireless terminal via a wireless network, and a user notification unit that gives a warning to a user upon receiving from the monitoring server a radio quality degradation alert at the wireless terminal. The monitoring server includes a future position prediction unit that predicts a future position of the wireless terminal based on the movement history of the wireless terminal, a radio propagation prediction unit that estimates radio quality in a service coverage area by using a radiowave propagation simulator, and a quality degradation prediction unit that predicts degradation of radio quality at the future position of the wireless terminal and transmits the radio quality degradation alert to the wireless terminal.

Still another aspect of certain embodiments of the present invention concerns a radio quality degradation prediction system including a wireless terminal and a monitoring server. The wireless terminal includes a positioning unit that determines a position of the wireless terminal and predicts a future position of the wireless terminal based on movement history of the wireless terminal, a radio propagation prediction result maintaining unit that receives, from the monitoring server, and maintains a result of the estimation of radiowave propagation in an area in which the wireless terminal is present, a radio quality degradation prediction unit that predicts degradation of radio quality at the future position of the wireless terminal and outputs a radio quality degradation alert, and a user notification unit that gives a user a warning about radio quality degradation based on the predicted degradation of radio quality. The monitoring server includes a radio propagation prediction unit that estimates radio quality in a service coverage area by using a radiowave propagation simulator.

Yet another aspect of certain embodiments of the present invention concerns a radio quality degradation prediction system in a multi-hop network in which wireless terminals perform communication relay, including a plurality of wireless terminals that receive a radio quality monitoring service and a monitoring server. The monitoring server includes a future position prediction unit that receives movement histories of the plurality of wireless terminals at a time and predicts a future position of each of the plurality of wireless terminals, a radio propagation prediction unit that estimates radio quality in a service coverage area using a radiowave propagation simulator based on the future position of each of the plurality of wireless terminals, and a quality degradation prediction unit that predicts degradation of radio quality at the future position of each of the plurality of wireless terminals and transmits a radio quality degradation alert to the wireless terminals.

Still another aspect of certain embodiments of the present invention concerns a wireless terminal used in a radio quality degradation prediction system, including a positioning unit that determines a position of the wireless terminal and notifies a monitoring server of movement history of the wireless terminal via a wireless network, and a user notification unit that gives a warning to a user upon receiving from the monitoring server a radio quality degradation alert at the wireless terminal.

Yet another aspect of certain embodiments of the present invention concerns a wireless terminal used in a radio quality degradation prediction system, including a positioning unit that determines a position of the wireless terminal, a future position prediction unit that predicts a future position of the wireless terminal based on movement history of the wireless terminal, a radio propagation prediction result maintaining unit that receives, from a monitoring server, and maintains a result of estimating radiowave propagation in an area in which the wireless terminal is present, a radio quality degradation prediction unit that predicts degradation of radio quality at the future position of the wireless terminal and outputs a radio quality degradation alert, and a user notification unit that gives a user a warning about radio quality degradation based on the predicted degradation of radio quality.

Still another aspect of certain embodiments of the present invention concerns a monitoring server used in a radio quality degradation prediction system, including a radio propagation prediction unit that estimates radio quality in a service coverage area by using a radiowave propagation simulator.

Yet another aspect of certain embodiments of the present invention concerns a monitoring server used in a radio quality degradation prediction system in a multi-hop network in which wireless terminals perform a communication relay, including a future position prediction unit that receives movement histories of the plurality of wireless terminals and predicts a future position of each of the plurality of wireless terminals, a radio propagation prediction unit that estimates radio quality in a service coverage area using a radiowave propagation simulator based on the future position of each of the plurality of wireless terminals, and a quality degradation prediction unit that predicts degradation of radio quality at the future position of each of the plurality of wireless terminals and based on the predicted degradation of radio quality transmits a radio quality degradation alert to the wireless terminals.

Still another aspect of certain embodiments of the present invention concerns a radio quality degradation prediction method including a positioning operation including determining a position of a wireless terminal and notifying of movement history of the wireless terminal via a wireless network, a future position prediction operation including predicting a future position of the wireless terminal based on the movement history of the wireless terminal, a radio propagation prediction operation including estimating radio quality in a service coverage area by using a radiowave propagation simulator, a quality degradation prediction operation including predicting degradation of radio quality at the future position of the wireless terminal and transmitting a radio quality degradation alert to the wireless terminal, and a user notification operation including giving a warning to a user upon receiving the radio quality degradation alert at the wireless terminal.

Yet another aspect of certain embodiments of the present invention concerns a computer readable tangible medium containing a program of instructions for enabling a computer, serving as a wireless terminal used in a radio quality degradation prediction system, to execute processes including a positioning process including determining a position of the wireless terminal and notifying a monitoring server of movement history of the wireless terminal via a wireless network, and a user notification process including giving a warning to a user upon receiving from the monitoring server a radio quality degradation alert at the wireless terminal from the monitoring server.

Still another aspect of certain embodiments of the present invention concerns a computer readable tangible medium containing a program of instructions for enabling a computer, serving as a wireless terminal used in a radio quality degradation prediction system, to execute processes including a positioning process including determining a position of the wireless terminal, a future position prediction process including predicting a future position of the wireless terminal based on movement history of the wireless terminal, a radio propagation prediction result maintaining process including receiving, from a monitoring server, and maintaining a result of estimating radiowave propagation in an area in which the wireless terminal is present, a radio quality degradation prediction process including predicting degradation of radio quality at the future position of the wireless terminal and outputs a radio quality degradation alert, and a user notification process including giving a user a warning about radio quality degradation based on the predicted degradation of radio quality.

Yet another aspect of certain embodiments of the present invention concerns a computer readable tangible medium containing a program of instructions for enabling a computer, serving as a monitoring server used in a radio quality degradation prediction system, to execute processes including a radio propagation prediction process including estimating radio quality in a service coverage area by using a radiowave propagation simulator.

Still another aspect of certain embodiments of the present invention concerns s computer readable tangible medium containing a program of instructions for enabling a computer, serving as a monitoring server used in a radio quality degradation prediction system in a multi-hop network in which wireless terminals perform a communication relay, to execute processes including a future position prediction process including receiving movement histories of the plurality of wireless terminals and predicting a future position of each of the plurality of wireless terminals, a radio propagation prediction process including estimating radio quality in a service coverage area using a radiowave propagation simulator based on the future position of each of the plurality of wireless terminals, and a quality degradation prediction process including predicting degradation of radio quality at the future position of each of the plurality of wireless terminals and transmitting a radio quality degradation alert to the wireless terminals based on the predicted degradation of radio quality.

According to certain embodiments of the present invention, degradation of radio quality at a future position of a wireless terminal can be predicted sufficiently in advance and with accuracy. This is because movement characteristics of human beings are easy to predict because they do not change the speed or direction of their movement suddenly as compared to prediction of a complex radiowave propagation environment in an urban area. Also, this is because it is possible to estimate a complex radiowave propagation environment with a high degree of accuracy, by using a radiowave propagation simulator based on a ray tracing method or the like.

Further, according to certain embodiments of the present invention, it is possible to predict degradation of radio quality at a future position within a multi-hop network. Since wireless terminals relay communication in a multi-hop network, service available areas continuously change with movement of a plurality of wireless terminals. Since movement of a plurality of wireless terminals can be predicted and a range in which relay by the wireless terminals is possible at a future point in time can be estimated, it is possible to predict radio quality degradation for an arbitrary wireless terminal.

### BRIEF DESCRIPTION OF THE DRAWINGS

Aspects of embodiments of the present invention will become more apparent by describing in detail embodiments thereof with reference to the accompanying drawings, in which:

FIG. 1 is a block diagram showing a configuration of a radio quality degradation prediction system according to a first embodiment of the present invention,

FIG. 2 is a flowchart illustrating the operations of quality degradation prediction unit of the radio quality degradation prediction system according to the first embodiment of the present invention,

FIG. 3 is a block diagram showing a configuration of a radio quality degradation prediction system according to a second embodiment of the present invention,

FIG. 4 is a block diagram showing a configuration of a radio quality degradation prediction system according to a third embodiment of the present invention.

### DETAILED DESCRIPTION OF EMBODIMENTS

Hereinafter, embodiments of the present invention will be described with reference to drawings.

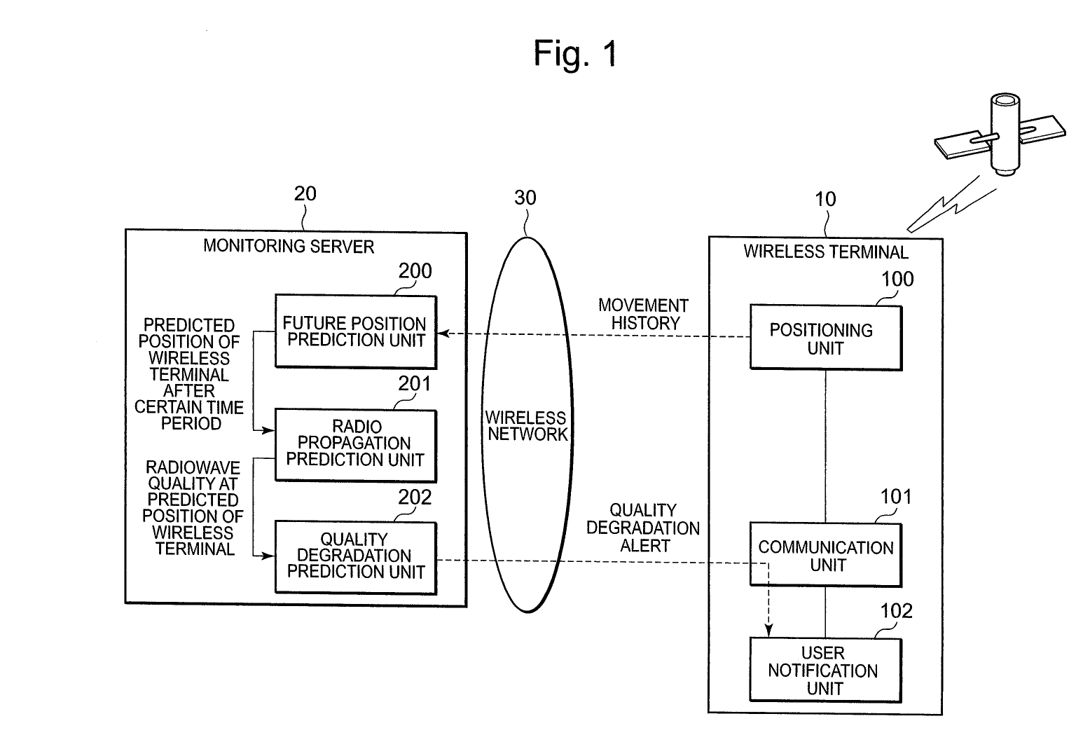

A configuration of a radio quality degradation prediction system according to a first embodiment of the present invention is shown in FIG. 1. In FIG. 1, the radio quality degradation prediction system according to the first embodiment of the present invention includes a wireless terminal 10 and a monitoring server 20. The wireless terminal 10 and the monitoring server 20 perform wireless communication with each other via a wireless network 30.

The wireless terminal 10 includes positioning unit 100, communication unit 101 and user notification unit 102. The positioning unit determines the position of the terminal 10 using signals received from a GPS satellite or the like. The communication unit 101 performs communication via the wireless network 30. And, the user notification unit 102 gives a user a warning upon receiving a quality degradation alert from the monitoring server 20. The positioning unit 100 also notifies the monitoring server 20 of movement history of the wireless terminal 10 via the wireless network 30.

The user notification unit 102 may give the user the warning by, for example, issuing of a warning tone, displaying of an alert popup on a display, or the like. When a goggle-type display worn by the user is adopted as a display device, rather than a standard type of display, a color corresponding to the degradation condition of radiowave quality may be applied to a view that is seen through the goggle.

The monitoring server 20 includes future position prediction unit 200, radio propagation prediction unit 201, and quality degradation prediction unit 202.

The future position prediction unit 200 receives movement history from the positioning unit 100 of the wireless terminal 10 and predicting a future position of the wireless terminal 10 from the movement history. For prediction of a future position from movement history, a method based on a Kalman filter is often employed, which is detailed in Chapter 9, “GPS Navigation Algorithm”, of Bradford W. Parkinson, James J. Spilker Jr, ed., “Global Positioning System Theory and Applications, Volume I”, for instance.

As future position prediction using a Kalman filter is well known to those skilled in the art, description thereof is omitted.

The radio propagation prediction unit 201 estimates radio quality in the vicinity of an area in which the wireless terminal 10 is present. The radio propagation prediction unit 201 also outputs an estimated value of radio quality at a predicted position where the wireless terminal 10 would be after elapse of a certain time period. This estimated value of radio quality is sent by the future position prediction unit 200, to the quality degradation prediction unit 202.

For estimation of radiowave propagation, a method using statistical equations, such as Hata model, and a method using a decision theoretic method, such as three-dimensional ray tracing, are generally known. And a suitable method may be adopted according to required accuracy, required calculation time or the like.

The quality degradation prediction unit 202 predicts degradation of radio quality at a future position of the wireless terminal based on radiowave quality estimation information input from the radio propagation prediction unit 201, and creates and transmits a quality degradation alert to the wireless terminal 10.

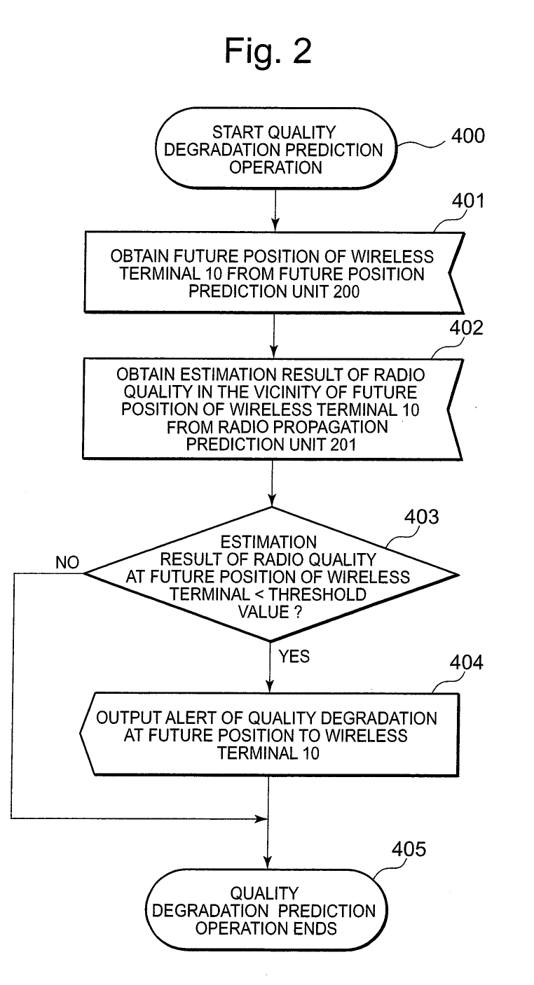

Next, operations of the quality degradation prediction unit 202 are described with reference to FIG. 2. In FIG. 2, the quality degradation prediction unit 202 starts prediction operations (Step 400), and the quality degradation prediction unit 202 obtains a future position of the wireless terminal 10 via the future position prediction unit 200 (Step 401).

The quality degradation prediction unit 202 then obtains a result of estimating radio quality in the vicinity of the future position of the wireless terminal 10 from the radio propagation prediction unit 201 (Step 402), and checks whether or not the result of estimating radio quality at the future position of the wireless terminal is below a predetermined threshold value (Step 403). If the result is better than the threshold value, the quality degradation estimation operation is terminated (Step 405).

However, if the result of estimating radio quality at the future position of the wireless terminal is below the predetermined threshold value, an alert about quality degradation at the future position is output to the wireless terminal 10 (Step 404), and the quality degradation prediction operation is terminated (Step 405).

By predicting a future position of the wireless terminal 10 and predicting degradation of radio quality at that position with a radiowave propagation simulator as described above, it is possible to alert the user of the wireless terminal 10 that radio quality will degrade and recommend that the user stay in the service area.

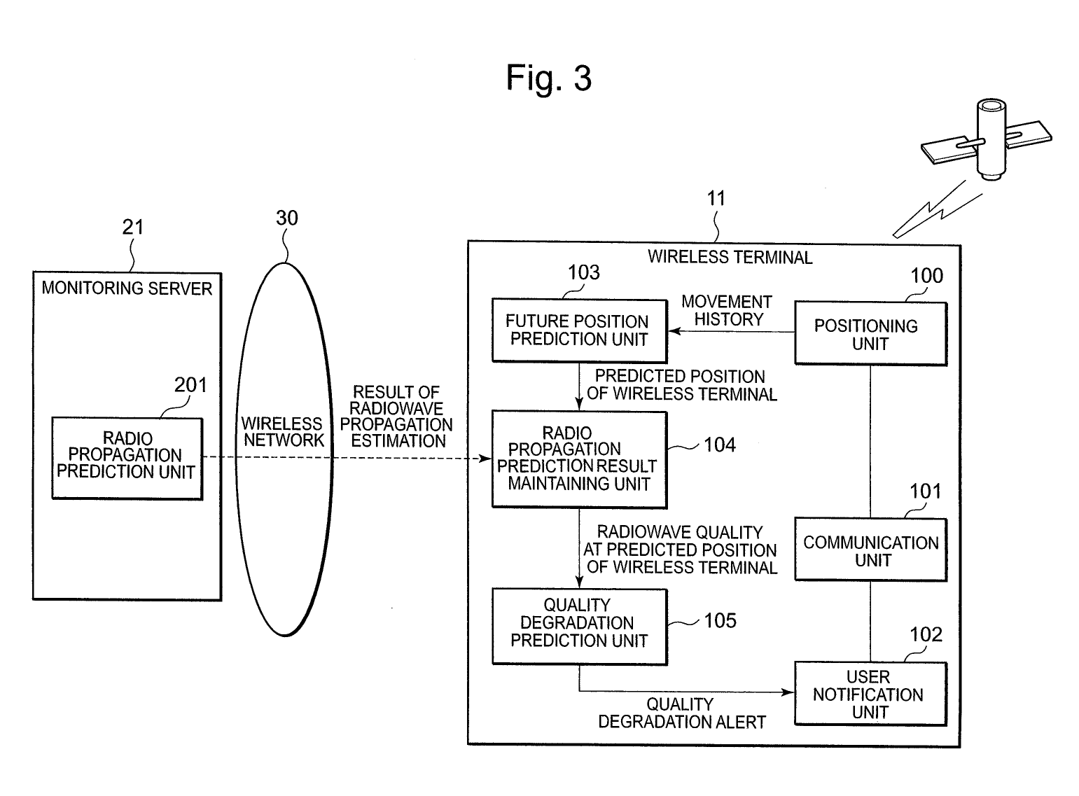

Next, a configuration of a radio quality degradation prediction system according to a second embodiment of the present invention is shown in FIG. 3. In the configuration of the radio quality degradation prediction system according to the first embodiment, the future position prediction unit and the quality degradation prediction unit are provided in the monitoring server. However, in a configuration of the radio quality degradation prediction system according to the second embodiment, the future position prediction unit and the quality degradation prediction unit are provided in the wireless terminal. Further, the wireless terminal is provided with a radio propagation prediction result maintaining unit and the radio propagation prediction unit but no other unit is required in the monitoring server. The configuration of the second embodiment is otherwise the same as the configuration of the first embodiment.

In FIG. 3, the radio quality degradation prediction system according to the second embodiment of the present invention includes a wireless terminal 11 and a monitoring server 21. The wireless terminal 11 and the monitoring server 21 perform wireless communication with each other via the wireless network 30.

In FIG. 3, the monitoring server 21 has the radio propagation prediction unit 201, and transmits a result of estimating radiowave propagation in the vicinity of an area, in which the wireless terminal 11 is present, to the wireless terminal 11 via the wireless network 30.

On the other hand, the future position prediction unit and the quality degradation prediction unit, which are provided in the monitoring server 20 in FIG. 1 that shows the configuration of the radio quality degradation prediction system according to the first embodiment of the present invention, are provided as a future position prediction unit 103 and a quality degradation prediction unit 105 in the wireless terminal 11. That is, the functions of the future position prediction unit and the quality degradation prediction unit of the monitoring server 20 in FIG. 1 have been transferred to the wireless terminal 11 side.

In addition, the wireless terminal 11 includes a radio propagation prediction result maintaining unit 104 that accumulates results of estimating radiowave propagation in the vicinity of an area in which the wireless terminal 11 is present. The positioning unit 100, communication unit 101, and user notification unit 102 are provided as in the wireless terminal 10 of the first embodiment (FIG. 1) and they have the same functions as in the first embodiment.

By having such a configuration, the radio quality degradation prediction system according to the second embodiment of the present invention eliminates the necessity for a wireless terminal to continually send its movement history over a network and obtain results of radio propagation prediction at short time intervals, and therefore reduces consumption of communication power.

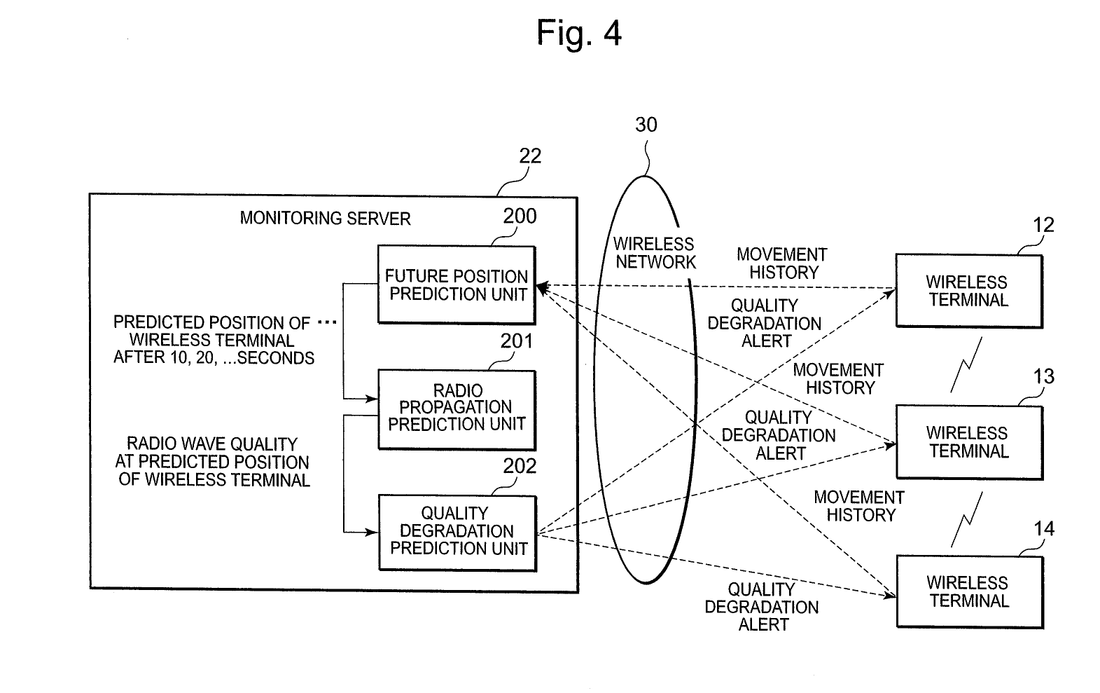

Next, a configuration of a radio quality degradation prediction system according to a third embodiment of the present invention is shown in FIG. 4. The radio quality degradation prediction system according to the third embodiment of the present invention is an application of a multi-hop network. In FIG. 4, the radio quality degradation prediction system according to the third embodiment of the invention includes a plurality of wireless terminals 12, 13 and 14 that receive a radiowave quality monitoring service, and a monitoring server 22 includes future position prediction unit 200, radio propagation prediction unit 201, and quality degradation prediction unit 202.

In the embodiment shown in FIG. 4, the wireless terminals 12, 13 and 14 form a multi-hop network and are capable of performing a radio relay with each other. The functions of the wireless terminals 12-14 and the monitoring server 22 are similar to the wireless terminal 10 and the monitoring server 20 of the first embodiment shown in FIG. 1.

The monitoring server 22 has future position prediction unit 200, radio propagation prediction unit 201, and quality degradation prediction unit 202.

The future position prediction unit 200 receives movement histories of the wireless terminals 12, 13 and 14 at a particular time and predicts future positions of the terminals.

The radio propagation prediction unit 201 estimates radio quality in a service coverage area based on the future positions of the wireless terminals 12, 13 and 14 by using a radiowave propagation simulator.

The quality degradation prediction unit 202 predicts degradation of radio quality at the future positions of the wireless terminals 12, 13 and 14, and transmits an alert about radio quality degradation to each of the wireless terminals 12, 13 and 14. As the configuration and functions of the wireless terminals 12 to 14 are the same as the terminal 10 of the first embodiment, description thereof is omitted.

In the third embodiment of the present invention, the future position prediction unit 200 of the monitoring server 22 receives movement histories of the wireless terminals 12, 13 and 14 at a particular time, and the radio propagation prediction unit 201 of the monitoring server 22 estimates a range within which a wireless signal of a multi-hop network can reach based on the terminals' future positions.

According to the third embodiment of the invention, therefore, service area quality in a multi-hop network at a future point in time can be estimated and an alert on quality degradation can be issued to the individual wireless terminals even though a service area changes in accordance with the position of a plurality of wireless terminals.

The processing operation of the radio quality degradation prediction system according to the embodiments of the present invention can be realized by causing a computer having a CPU and serving as a control unit, to read and execute a program stored in a storage medium, such as a ROM, RAM, or in a magnetic or optical storage medium, for example.

The embodiments of present invention are applicable to quality management techniques for predicting degradation of radio quality in a wireless communication network.

While embodiments of the present invention have been described in detail above, it is contemplated that numerous modifications may be made to the above embodiments without departing from the spirit and scope of the present invention which is defined by the following claims.

What is claimed is:

1. A radio quality degradation prediction system comprising:
a wireless terminal; and
a monitoring server,
wherein the wireless terminal comprises:
a positioning unit that determines a position of the wireless terminal and notifies the monitoring server of movement history of the wireless terminal via a wireless network; and
a user notification unit that gives a warning to a user upon receiving from the monitoring server a radio quality degradation alert at the wireless terminal, and
wherein the monitoring server comprises:
a future position prediction unit that predicts a future position of the wireless terminal based on the movement history of the wireless terminal;
a radio propagation prediction unit that estimates radio quality in a service coverage area by using a radiowave propagation simulator; and
a quality degradation prediction unit that predicts degradation of radio quality at the future position of the wireless terminal and transmits the radio quality degradation alert to the wireless terminal.

2. A radio quality degradation prediction system comprising:
a wireless terminal; and
a monitoring server,
wherein the wireless terminal comprises:
a positioning unit that determines a position of the wireless terminal and predicts a future position of the wireless terminal based on movement history of the wireless terminal;
a radio propagation prediction result maintaining unit that receives, from the monitoring server, and maintains a result of estimation of radiowave propagation in an area in which the wireless terminal is present;
a radio quality degradation prediction unit that predicts degradation of radio quality at the future position of the wireless terminal and outputs a radio quality degradation alert; and
a user notification unit that gives a user a warning about radio quality degradation based on the predicted degradation of radio quality, and
wherein the monitoring server comprises:
a radio propagation prediction unit that estimates radio quality in a service coverage area by using a radiowave propagation simulator.

3. A radio quality degradation prediction system in a multi-hop network in which wireless terminals perform communication relay, comprising:
a plurality of wireless terminals that receive a radio quality monitoring service; and
a monitoring server,
wherein the monitoring server comprises:
a future position prediction unit that receives movement histories of the plurality of wireless terminals at a time and predicts a future position of each of the plurality of wireless terminals;
a radio propagation prediction unit that estimates radio quality in a service coverage area using a radiowave propagation simulator based on the future position of each of the plurality of wireless terminals; and
a quality degradation prediction unit that predicts degradation of radio quality at the future position of each of the plurality of wireless terminals and transmits a radio quality degradation alert to the wireless terminals.

4. A wireless terminal used in a radio quality degradation prediction system, comprising:
a positioning unit that determines a position of the wireless terminal and notifies a monitoring server of movement history of the wireless terminal via a wireless network; and
a user notification unit that gives a warning to a user upon receiving from the monitoring server a radio quality degradation alert at the wireless terminal.

5. A wireless terminal used in a radio quality degradation prediction system, comprising:
a positioning unit that determines a position of the wireless terminal;
a future position prediction unit that predicts a future position of the wireless terminal based on movement history of the wireless terminal;
a radio propagation prediction result maintaining unit that receives, from a monitoring server, and maintains a result of estimating radiowave propagation in an area in which the wireless terminal is present;
a radio quality degradation prediction unit that predicts degradation of radio quality at the future position of the wireless terminal and outputs a radio quality degradation alert; and
a user notification unit that gives a user a warning about radio quality degradation based on the predicted degradation of radio quality.

6. A monitoring server used in a radio quality degradation prediction system, comprising:
a radio propagation prediction unit that estimates radio quality in a service coverage area by using a radiowave propagation simulator.

7. The monitoring server according to claim 6, further comprises,
a future position prediction unit that predicts a future position of a wireless terminal based on the movement history of the wireless terminal; and
a quality degradation prediction unit that predicts degradation of radio quality at the future position of the wireless terminal and based on the predicted degradation of radio quality transmits a radio quality degradation alert to the wireless terminal.

8. A monitoring server used in a radio quality degradation prediction system in a multi-hop network in which wireless terminals perform a communication relay, comprising:
a future position prediction unit that receives movement histories of the plurality of wireless terminals and predicts a future position of each of the plurality of wireless terminals;
a radio propagation prediction unit that estimates radio quality in a service coverage area using a radiowave propagation simulator based on the future position of each of the plurality of wireless terminals; and
a quality degradation prediction unit that predicts degradation of radio quality at the future position of each of the plurality of wireless terminals and based on the predicted degradation of radio quality transmits a radio quality degradation alert to the wireless terminals.

9. A radio quality degradation prediction method comprising:
a positioning operation comprising determining a position of a wireless terminal and notifying of movement history of the wireless terminal via a wireless network;
a future position prediction operation comprising predicting a future position of the wireless terminal based on the movement history of the wireless terminal;
a radio propagation prediction operation comprising estimating radio quality in a service coverage area by using a radiowave propagation simulator;
a quality degradation prediction operation comprising predicting degradation of radio quality at the future position of the wireless terminal and transmitting a radio quality degradation alert to the wireless terminal; and
a user notification operation comprising giving a warning to a user upon receiving the radio quality degradation alert at the wireless terminal.

10. The radio quality degradation prediction method according to claim 9, further comprises:
a radio propagation prediction result maintaining operation comprising receiving, from a monitoring server, and maintaining the result of estimation of radiowave propagation in an area in which the wireless terminal is present.

11. A computer readable tangible medium containing a program of instructions for enabling a computer, serving as a wireless terminal used in a radio quality degradation prediction system, to execute processes comprising:
a positioning process comprising determining a position of the wireless terminal and notifying a monitoring server of movement history of the wireless terminal via a wireless network; and
a user notification process comprising giving a warning to a user upon receiving from the monitoring server a radio quality degradation alert at the wireless terminal.

12. A computer readable tangible medium containing a program of instructions for enabling a computer, serving as a wireless terminal used in a radio quality degradation prediction system, to execute processes comprising:
a positioning process comprising determining a position of the wireless terminal;
a future position prediction process comprising predicting a future position of the wireless terminal based on movement history of the wireless terminal;
a radio propagation prediction result maintaining process comprising receiving, from a monitoring server, and maintaining a result of estimating radiowave propagation in an area in which the wireless terminal is present;
a radio quality degradation prediction process comprising predicting degradation of radio quality at the future position of the wireless terminal and outputting a radio quality degradation alert; and
a user notification process comprising giving a user a warning about radio quality degradation based on the predicted degradation of radio quality.

13. A computer readable tangible medium containing a program of instructions for enabling a computer, serving as a monitoring server used in a radio quality degradation prediction system, to execute processes comprising:
a radio propagation prediction process comprising estimating radio quality in a service coverage area by using a radiowave propagation simulator.

14. The computer readable tangible medium containing the program according to claim 13, further comprising:
a future position prediction process comprising predicting a future position of a wireless terminal based on the movement history of the wireless terminal; and
a quality degradation prediction process comprising predicting degradation of radio quality at the future position of the wireless terminal and transmitting a radio quality degradation alert to the wireless terminal.

15. A computer readable tangible medium containing a program of instructions for enabling a computer, serving as a monitoring server used in a radio quality degradation prediction system in a multi-hop network in which wireless terminals perform a communication relay, to execute processes comprising:
a future position prediction process comprising receiving movement histories of the plurality of wireless terminals and predicting a future position of each of the plurality of wireless terminals;
a radio propagation prediction process comprising estimating radio quality in a service coverage area using a radiowave propagation simulator based on the future position of each of the plurality of wireless terminals; and
a quality degradation prediction process comprising predicting degradation of radio quality at the future position of each of the plurality of wireless terminals and transmitting a radio quality degradation alert to the wireless terminals based on the predicted degradation of radio quality.
